(19) United States
(12) Patent Application Publication
(10) Pub. No.: US 2023/0195210 A1
(43) Pub. Date: Jun. 22, 2023

(54) DISPLAY DEVICE, DISPLAY METHOD AND DISPLAY PROGRAM

(71) Applicant: Nippon Telegraph and Telephone Corporation, Tokyo (JP)

(72) Inventors: Arinobu NIIJIMA, Musashino-shi, Tokyo (JP); Toki TAKEDA, Musashino-shi, Tokyo (JP); Takafumi MUKOUCHI, Musashino-shi, Tokyo (JP); Takashi SATO, Musashino-shi, Tokyo (JP)

(21) Appl. No.: 17/913,054

(22) PCT Filed: Mar. 25, 2020
(86) PCT No.: PCT/JP2020/013419

§ 371 Date: Sep. 20, 2022

(51) Int. Cl. G06F 3/01

(52) U.S. Cl. CPC G06F 3/011; G06F 3/016

(57) ABSTRACT

A presentation device 1 includes an obtaining unit 11 which obtains information to be notified to a user, a control unit 12 which inputs, to a presentation unit 13, an instruction for presenting a temperature stimulus if there is information to be notified to the user, and the presentation unit 13 which presents the temperature stimulus in response to the instruction for presenting the temperature stimulus received from the control unit 12 such that the user feels that temperature stimulus when the presentation unit touches a first part and the user does not feel the temperature stimulus when the presentation unit touches the second part which is less perceptive than the first part. The presentation unit 13 is provided at a location where the presentation unit can touch the first part by means of an action of the user.

### TECHNICAL FIELD

The present invention relates to a presentation device, a presentation method, and a presentation program.

### BACKGROUND ART

Tactile displays using vibration stimuli have been widely used as means for conveying information to users, and smartphones and smartwatches are typical examples thereof. Information delivery by means of a vibration stimulus is what is called push-type notification which allows information to be delivered regardless of the user's intention. The push-type notification is advantageous in that the user can obtain information immediately.

There is a method in which temperature stimuli may be presented by means of a mobile device such as a smart phone, for example (NPL 1).

In general, human cold receptors and warm receptors exist all over the body, but the spatial density and the discrimination threshold for temperature changes of the receptors vary greatly among body parts. It is known that the lips are the most sensitive to temperature stimuli, while the fingers, wrists, arms, and the like are less sensitive compared to the lips (NPL 2). It is also known that cold receptors fire at 25° C. and warm receptors fire at 27° C. (NPL 3). It is known that a Peltier element is embedded inside of a ring and the surface of a finger wearing the ring is allowed to perceive a temperature stimulus (NPL 4).

### CITATION LIST

### Non Patent Literature

[NPL 1] Reto Wettach et al., “A thermal information display for mobile applications” (2007)
[NPL 2] JOSEPH C. STEVENS and KENNETH K. CHOO, “Temperature sensitivity of the body surface over the life span” (1998)
[NPL 3] Ardem Patapoutian et al. “ThermoTRP channels and beyond mechanisms of temperature sensation” (2003)
[NPL 4] Kening Zhu, a, Simon Perraultb, Taizhou Chena, Shaoyu Caia, Roshan Lalintha Peirisc, A sense of ice and fire: Exploring thermal feedback with multiple thermoelectric-cooling elements on a smart ring, International Journal of Human-Computer Studies 130 (2019) 234-247

### SUMMARY OF THE INVENTION

### Technical Problem

The user may find a push-type notification annoying in some cases because the information notification intervenes regardless of the state of the ongoing user activity. NPL 4 discloses that, since the Peltier element embedded inside the ring allows the finger surface to perceive a temperature stimulus, a push-type notification is realized which can notify information regardless of the state of the user.

The present invention is devised in view of the above problems, and an object of the present invention is to provide a technique for allowing information to be notified at a timing desired by the user.

### Means for Solving the Problem

A presentation device of an aspect of the present invention includes an obtaining unit which obtains information to be notified to a user, a control unit which inputs, to a presentation unit, an instruction for presenting a temperature stimulus if there is information to be notified to the user, and the presentation unit which presents the temperature stimulus in response to the instruction for presenting the temperature stimulus received from the control unit such that the user feels the temperature stimulus when the presentation unit touches a first part and the user does not feel the temperature stimulus when the presentation unit touches a second part which is less perceptive than the first part, and the presentation unit is provided at a position where the presentation unit can touch the first part by means of an action of the user.

A presenting method of an aspect of the present invention includes the steps of: obtaining information to be notified to a user using a computer, inputting, to a presentation unit, an instruction for presenting a temperature stimulus using the computer if there is information to be notified to the user, presenting the temperature stimulus in response to the instruction for presenting the temperature stimulus received by the presentation unit such that the user feels the temperature stimulus when the presentation unit touches a first part and the user does not feel the temperature stimulus when the presentation unit touches a second part which is less perceptive than the first part, and determining whether there is information to be notified by causing the presentation unit to touch the first part by the user.

An aspect of the present invention provides a presentation program for causing a computer to function as the presentation device.

### Effects of the Invention

According to the present invention, it is possible to provide a technique for allowing information to be notified at a timing desired by the user.

### BRIEF DESCRIPTION OF DRAWINGS

FIG. 1 is a diagram for explaining a hardware configuration of a presentation device according to an embodiment of the present invention.

FIG. 2 is a diagram for explaining functional blocks of the presentation device according to the embodiment of the present invention.

FIG. 3 is a flowchart for explaining control processing performed by a control unit of the presentation device.

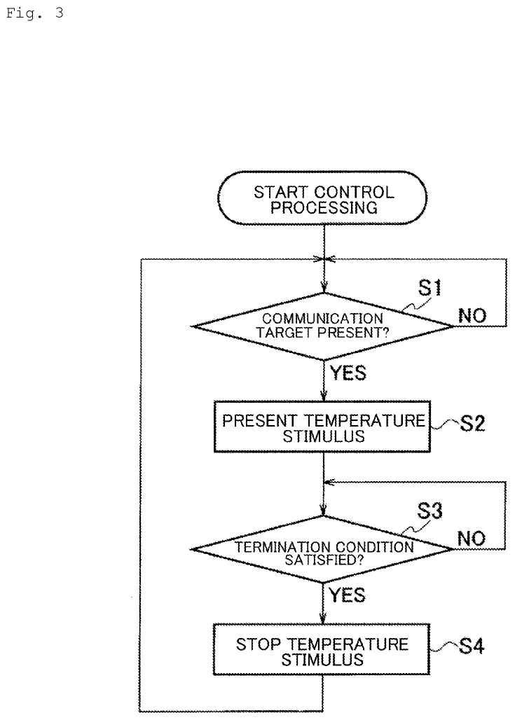

FIG. 4 is a view for explaining a ring to which the presentation device according to the embodiment of the present invention is mounted (with one Peltier element).

FIG. 5 is a view for explaining a ring to which the presentation device according to the embodiment of the present invention is mounted (with two Peltier elements).

FIG. 6 illustrates the result of a first experiment.

FIG. 7 illustrates the result of a second experiment.

### DESCRIPTION OF EMBODIMENTS

Hereinafter, an embodiment of the present invention will be described with reference to the drawings. The same parts in the drawings will be designated by the same reference characters and their description will not be provided.

(Presentation Device)

A presentation device 1 according to an embodiment of the present invention notifies the user of information by means of a pull-type notification using a presentation unit 13 (a Peltier element 2) which causes the user to feel a temperature stimulus when the unit touches a part sensitive to a temperature stimulus such as the lips and does not cause the user to feel a temperature stimulus when the unit touches a part which is insensitive to a temperature stimulus such as a finger or an arm. The user causes the presentation unit 13 to touch a part sensitive to a temperature stimulus such as the lips at a timing at which the user desires to obtain information and apprehends the presence of information upon feeling a temperature stimulus.

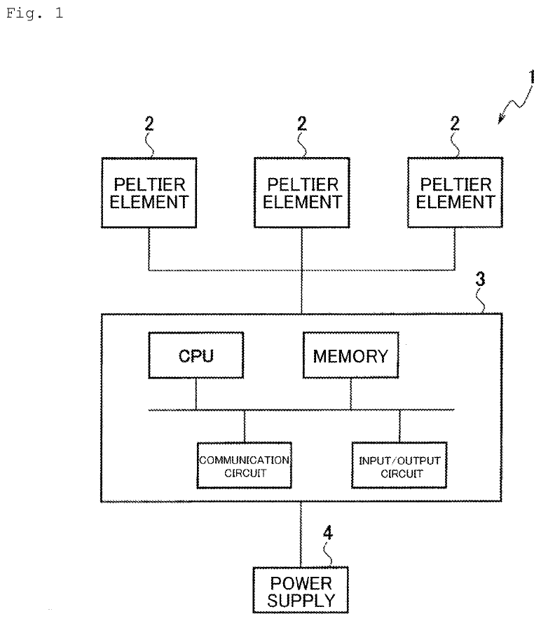

Referring to FIG. 1, an exemplary hardware structure of the presentation device 1 will be described. The presentation device 1 includes the Peltier element 2, a microcontroller 3 (a microcontroller), and a power supply 4 as hardware.

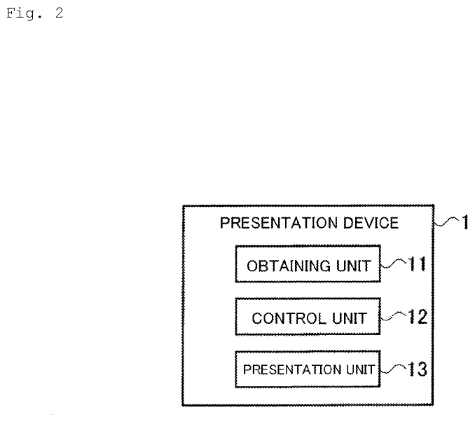

The Peltier element 2 is one of thermoelectric elements (semiconductor thermoelectric elements) that use the Peltier effect. The Peltier element 2 functions as the presentation unit 13 in FIG. 2. In the embodiment of the present invention, the Peltier element 2 is used as an example of the thermoelectric element, but any of other thermoelectric elements may be used to present a temperature stimulus. In the embodiment of the present invention, the presentation device 1 has one or more Peltier element 2. The Peltier element 2 used in the embodiment of the present invention is a single element type having a size of 3.5 mm×3.35 mm.

The Peltier element 2 includes a PN junction of which temperature changes in response to reception of current. The amount of temperature change in the PN junction of the Peltier element 2 is controlled by means of the amount of electric power flowing through the Peltier element 2. The Peltier element 2 is provided in such a manner that the temperature of the PN junction is transmitted to the user who contacts with the presentation device 1. The Peltier element 2 may be provided such that the PN junction is provided in an exposed manner on the surface of the presentation device 1 or an arbitrary member such as a ceramic substrate for transmitting heat may be provided outside the PN junction, for example. The user receives a temperature stimulus by touching the PN junction or the member covering the PN junction. The size of the Peltier element 2 is selected as appropriate depending on the use method as will be described.

The microcontroller 3 is a computer including a CPU, a memory, a communication circuit, and an input/output circuit and functions as an obtaining unit 11 and a control unit 12 shown in FIG. 2. The microcontroller 3 is connected to each of the Peltier elements 2 by using lead wires (not shown) or the like. The microcontroller 3 applies current to the Peltier element 2 and causes the Peltier element 2 to present a temperature stimulus. The microcontroller 3 controls the driving of the Peltier element 2.

By the microcontroller 3 applying current to the Peltier element 2, the temperature of the PN junction of the Peltier element is changed and a temperature stimulus can be presented to the part touched by the presentation device 1. The microcontroller 3 can select a cold stimulus or a warm stimulus as the temperature stimulus by controlling the current value (the direction of the current and the magnitude of the current) applied to the Peltier element 2 and can also control the temperature to be presented (the strength of the temperature stimulus).

The power supply 4 supplies electric power to the microcontroller 3.

In the presentation device 1, the functions of the obtaining unit 11, the control unit 12, and the like may be implemented by the CPU reading out and executing a prescribed program. The program for the presentation device 1 can be stored in a computer-readable recording medium such as an HDD, an SSD, a USB (Universal Serial Bus) memory, a CD (Compact Disc), and a DVD (Digital Versatile Disc), or delivered over a network.

Referring to FIG. 2, the functional blocks of the presentation device 1 according to the embodiment of the present invention will be described. The presentation device 1 includes the obtaining unit 11, the control unit 12, and the presentation unit 13.

The obtaining unit 11 obtains information to be notified to a user. The information to be obtained by the obtaining unit 11 may be information obtained from a server or a sensor over a communication network or may be information obtained by processing the information obtained from these sources, for example. The information to be obtained can be reception of an e-mail message, a notification by SNS, a notification of coming home of a child, or a notification of changes in stock prices, for example.

If there is information to be notified to the user, the control unit 12 inputs an instruction for presenting a temperature stimulus to the presentation unit 13. The control unit 12 inputs the instruction for presenting the temperature stimulus to the presentation unit 13 after the obtaining unit 11 obtains the information to be notified to the user. At the time, the presentation unit 13 may specify the temperature to be presented by the presentation unit 13.

The control unit 12 also inputs, to the presentation unit 13, an instruction for terminating the presentation of the temperature stimulus if a prescribed termination condition is satisfied. The termination condition is the elapse of a prescribed time period after the presentation of the temperature stimulus is started, or a notification that the user has obtained the information, for example.

Referring to FIG. 2, the temperature control processing performed by the control unit 12 will be described.

First, the control unit 12 determines whether there is a notification target in step S1. The control unit 12 determines that there is a notification target if the obtaining unit 11 has obtained information to be notified to the user and the information has not been notified to the user, for example. If there is no notification target, the control unit 12 stands by for a notification target.

If there is a notification target, in step S2, the control unit 12 transmits, to the presentation unit 13, an instruction for presenting a temperature stimulus.

The control unit 12 stands by until it is determined in step S3 that the termination condition is satisfied. If the termination condition is satisfied, the control unit 12 transmits an instruction for stopping the temperature stimulus to the presentation unit 13 in step S4.

In the embodiment of the present invention, the control unit 12 instructs the presentation unit 13 to present a cold stimulus at 25° C. or a warm stimulus at 27° C. 25° C. is the temperature at which cold receptors fire and 27° C. is the temperature at which warm receptors fire. The presentation unit 13 may change whether the presentation unit 13 gives a cold stimulus or a warm stimulus depending on the environment such as the outside air temperature. The control unit 12 may cause the presentation unit 13 to give a cold stimulus in a warm environment and causes the presentation unit 13 to give a warm stimulus in a cold environment, for example.

The presentation unit 13 presents the temperature stimulus such that the user feels the temperature stimulus when the unit touches a first part and the user does not feel the temperature stimulus when the unit touches a second part which is less sensitive than the first part. The presentation unit 13 may be implemented by a Peltier element, for example. The first part may be the lips and the like which are sensitive to the temperature stimulus and the second part may be any of the fingers, the arms, and the like which are insensitive to the temperature stimulus.

The presentation unit 13 presents a temperature stimulus after receiving an instruction for presenting the temperature stimulus from the control unit 12 and stops the temperature stimulus after receiving an instruction for stopping the temperature stimulus from the control unit 12.

It is known that a user is more likely to feel a temperature stimulus when the temperature of a temperature stimulus is higher or lower than the room temperature, and as the area for presenting a temperature increases, the user is more likely to feel the temperature stimulus. The presentation unit 13 has such a temperature or an area that the user feels a temperature stimulus when the unit touches the first part and the user does not feel the temperature stimulus when the unit touches the second part. By adjusting the temperature or area of a temperature stimulus presented by the presentation unit 13, the strength of the temperature stimulus can be adjusted, and the presentation unit 13 can be formed such that the temperature stimulus is presented when the unit touches a temperature sensitive part, and the temperature stimulus is not presented when the unit touches any of the other parts.

The presentation unit 13 is provided at a location where the unit can touch the first part by means of an action of the user. In this way, the user can check the presence or absence of information to be notified by placing the presentation unit 13 in contact with the first part at the timing at which the user desires to obtain information.

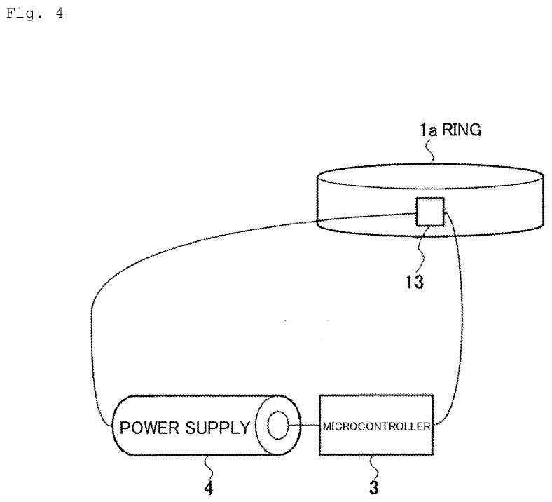

The presentation unit 13 (Peltier element 2) is provided in a ring 1a, which is a mounting fixture mounted on the body of the user as shown in FIG. 4, for example. The presentation unit 13 is embedded in the front side part of the ring. More specifically, the ring 1a is configured such that the PN junction of the Peltier element 2 of which temperature changes in accordance with application of current is located on the surface of the ring and is not in contact with the finger. If the lips or other parts that are sensitive to a temperature stimulus directly or indirectly touch the PN junction where the temperature changes in accordance with application of current, the user can receive the temperature stimulus.

The finger wearing the ring 1a, the arm, or the like which can be frequently touched by the ring 1a is more insensitive to a temperature stimulus than the lips. Suppose that current is applied to the presentation unit 13 in the ring 1a, and the ring can give a temperature stimulus to the lips. In the above state, the ring 1a will not give a temperature stimulus even by accidentally contacting the finger or arm. Meanwhile, if the user puts the ring 1a, especially the presentation unit 13, on the lips at the timing at which the user desires to obtain information, the ring 1a gives a temperature stimulus to the user's lips. In this way, if the user intentionally places the presentation unit 13 in contact with a part sensitive to temperature at a desired timing, the ring 1a can carry out a pull-type notification that enables the user to obtain information at the desired timing.

If a Peltier element is embedded inside the ring, the user can constantly receive a temperature stimulus by means of the Peltier element, and the temperature stimulus by means of the Peltier element can be what is called push-type notification, for example. In contrast, in the embodiment of the present invention, the presentation unit 13 (Peltier element 2) is embedded in the front side part of the ring 1a, and the user does not receive a temperature stimulus by the Peltier element unless the user consciously touches the presentation unit 13.

The presentation unit 13 is configured to give a temperature stimulus when the unit contacts a part which is sensitive to the temperature stimulus and does not provide a temperature stimulus when the unit contacts a part which is insensitive to the temperature stimulus. In this way, even if the presentation unit 13 is capable of giving a temperature stimulus, the user does not receive the temperature stimulus unless the user consciously performs the operation of causing the presentation unit 13 to touch the part sensitive to the temperature stimulus. The user can confirm the presence/absence of the temperature stimulus at the user's desired timing.

The presentation unit 13 has a raised shape with respect to a ring or any of other mounting fixtures. Even if the presentation unit 13 is in contact with the first part, if the parts other than the presentation unit 13 are also in contact with the first part, the user may not apprehend the temperature stimulus appropriately by means of the presentation unit 13. Therefore, if the presentation unit 13 is provided on a ring, a bracelet, or any of other accessories, the presentation unit 13 is formed to have a raised shape with respect to the body part of the accessory, and accordingly only the presentation unit 13 can be in contact with the first part without letting the main body part of the accessory contact the first part. The periphery of the part provided with the presentation unit 13 can be formed to be lower than the surface of the presentation unit 13.

In the ring 1a shown in FIG. 4, the presentation unit 13 (the PN junction of the Peltier element 2) is formed to have a raised shape above the annular part of the ring 1a. Alternatively, the periphery of the part of the ring 1a provided with the presentation unit 13 is formed to have a recessed shape, so that the presentation unit 13 (the PN junction of the Peltier element 2) can be provided to be relatively raised above the periphery.

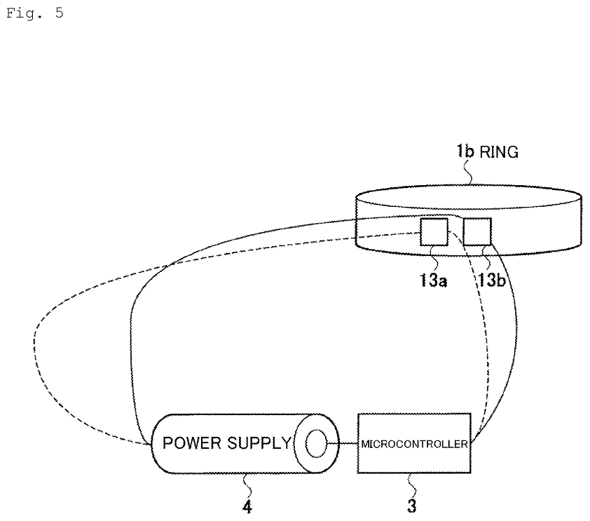

As shown in FIG. 5, the presentation unit 13 may have a first presentation unit 13a and a second presentation unit 13b. In the example shown in FIG. 5, the first presentation unit 13a and the second presentation unit 13b are connected in parallel. A plurality of control units 12 input an instruction for presenting a temperature stimulus to the first presentation unit 13a and do not input an instruction for presenting a temperature stimulus to the second presentation unit 13b. The first presentation unit 13a is used to present a notification of information and the second presentation unit 13b is used as a reference to determine temperature change in the first presentation unit 13a.

Although the temperature of the Peltier element 2 changes in accordance with application of current, the temperature of the Peltier element 2 may change with or without application of current depending on the environment in which the Peltier element 2 is placed, and the temperature change may be difficult to be aware of. As shown in FIG. 5, the ring 1b has the first presentation unit 13a and the second presentation unit 13b. The first presentation unit 13a and the second presentation unit 13b are connected to the microcontroller 3 and the power supply 4 in the same way. Current is applied to the first presentation unit 13a in accordance with to an instruction from the control unit 12 and no current is applied to the second presentation unit 13b under the control by the control unit 12. As a result, a difference in temperature change occurs between the first and second presentation units 13a and 13b depending on the presence/absence of application of current by the control unit 12.

The user can touch the first presentation unit 13a and the second presentation unit 13b separately or simultaneously and can apprehend the presence/absence of a notification of information depending on whether the temperature stimulus given by the first presentation unit 13a differs from the temperature stimulus given by the second presentation unit 13b. Such a presentation device (ring 1b) with multiple presentation units can inform the user of the presence/absence of information robustly with respect to environmental changes.

As other examples, even if the presentation device 1 includes only one presentation unit 13, the device can notify the user of the presence or absence of information robustly with respect to environmental changes. The presentation unit 13 does not always present a constant temperature stimulus but switches between different temperatures, such as switching between warm and cold stimuli and repeating turning on and off the voltage every few seconds, for example. This enables the user to determine whether the temperature stimulus received from the presentation device 1 is caused by environmental changes or the control unit 12.

The presentation unit 13 may include a presentation unit for each notification kind. The first presentation unit 13a may indicate the reception of an e-mail message and the second presentation unit 13b may indicate a notification of stock price changes, for example. Also in this case, a presentation unit for reference may be provided for each presentation unit. The user can obtain information about the presence/absence of desired information at the user's desired timing by causing the lips to contact with the presentation unit which indicates the presence/absence of desired information.

Even if the presentation device 1 includes one presentation unit 13, the pattern of temperature stimuli may be changed for each kind of notification. Different notification kinds may be associated with warm and cold stimuli, or different notification kinds may be associated with repeating patterns of on and off states of the temperature stimuli, for example.

In the embodiment of the present invention, the lips are described as a sensitive part of the body in temperature perception, and fingers, wrists, arms, or other parts are listed as insensitive parts of the body in temperature perception, but the present invention is not limited thereto.

If the Peltier element 2 is used as the presentation unit 13 according to the embodiment of the present invention, the range for giving a temperature stimulus can be changed by controlling the presentation area of the temperature stimulus or the amount of temperature change. Control may be performed such that by expanding the presentation area of the temperature stimulus, the temperature stimulus is given not only to the lips but also to the face. Also, the presentation area and the amount of temperature change of the temperature stimulus can be adjusted such that the upper body can perceive the stimulus, but the lower body may not perceive the stimulus.

Next, experiments related to the presentation unit 13 will be described.

(First Experiment)

In a first experiment, in order to examine the feasibility of the method for presenting a temperature stimulus which can be perceived only in a specific part using a Peltier element, the temperature perception accuracy at each part is examined.

The subjects are 12 men and women in their twenties to fifties. The room temperature is 25° C. The skin temperature of the subjects is from 28° C. to 34° C.

The subjects each touch the Peltier element with (1) the fingertip of the index finger of the right hand, (2) the inside of the wrist of the right hand, and (3) the lips.

The temperature of the Peltier element of the element type is controlled to be either a temperature which gives a warm stimulus (27° C.) or a temperature which gives a cold stimulus (25° C.), and the temperature stimulus is presented to each part of the subjects. The subjects touch the Peltier element with the above three parts and answer whether the subject feels a warm stimulus or a cold stimulus. The presentation of the stimulus is repeated several times with each part. The kinds of the temperature stimuli and the order of the parts are different among the subjects.

As an examination method, the percentage of correct answers which indicates whether the subject answers the correct temperature stimulus and the Chi-square test (a significance level of 1% corrected by the Bonferroni method) are used. In the Chi-square test, it is determined that the subject can perceive a temperature stimulus when there is a significant difference with respect to the percentage of correct answers when the subject answers a warm stimulus or a cold stimulus randomly.

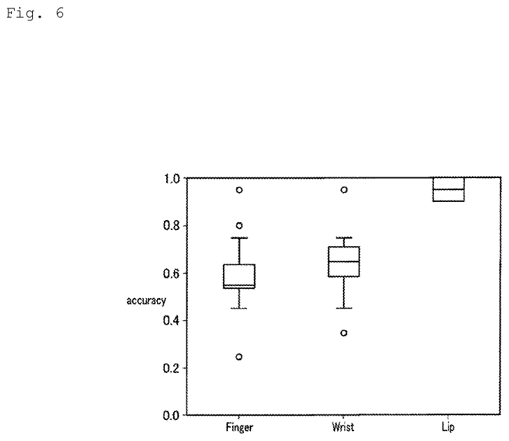

FIG. 6 is a box-and-whisker plot in which the result of the first experiment is summarized. The lines inside the boxes each indicate the median, and the round points outside the whiskers indicate outliers.

The median of correct answer percentage when touching with the finger was 55%, the median of correct answer percentage when touching with the wrist was 65%, and the median of correct answer percentage when touching with the lips was 95%. It was found that the median of correct answer percentage with the lips was higher than those with the finger and the wrist. A chi-square test showed that there was no significant difference between the finger (p=0.082) and the wrist (p=0.056), while there was a significant difference with lips (p<0.0033) with a significance level of 1%. As can be understood from the result, the lips can perceive a temperature stimulus even if the finger and wrist may not perceive a temperature stimulus.

The result of the first experiment indicates that a temperature stimulator which gives a temperature stimulus which can be perceived only with a specific part of the body can be provided by appropriately controlling the strength of the temperature stimulus to be presented.

(Second Experiment)

In a second experiment, the perception accuracy when multiple temperature stimuli are presented at the same time will be examined in order to examine whether the stimuli can be perceived individually.

The subjects are 12 men and women in their twenties to fifties. The room temperature is 25° C. The skin temperature of the subjects is from 28° C. to 34° C.

Two Peltier elements are arranged side by side with a distance of 5 mm therebetween. The subject touches the Peltier element with the lower lip.

Each of the subjects touches the two Peltier elements with the lower lip and is asked to answer whether the subject feels a warm stimulus or a cold stimulus from each of the Peltier elements. The presentation of the stimuli is repeated multiple times to each of the parts. The order of the temperature stimuli is different among the subjects.

As an examination method, the correct answer percentage, which indicates whether the subject answers the correct temperature stimulus and the Chi-square test are used. In the Chi-square test, it is determined that the subject can perceive multiple temperature stimuli if there is a significant difference with respect to the correct answer percentage when the subjects answer a warm or cold stimulus randomly.

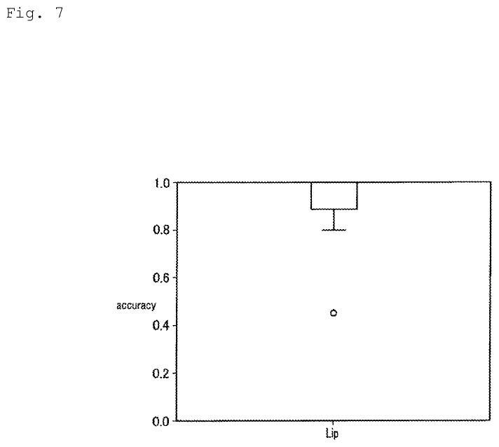

FIG. 7 is a box-and-whisker plot in which the experiment results of the second experiment are summarized. The lines in the boxes each indicate the median, and the round points outside the whiskers indicate outliers.

Seven subjects out of the twelve subjects had 100% correct answers, and the median was 100%. The result of the chi-square test indicates p<0.001 and the difference was significant with a significance level of 1%. As can be understood from the result, the lips can perceive multiple different temperature stimuli simultaneously.

In general, vibration stimuli are used in wearable devices. Tactile receptors for perceiving vibration stimuli are distributed throughout the body. If a wearable device presents a vibration stimulus, the stimulus would be perceived also in locations other than the location of the device, which is a push-type notification.

In contrast, the presentation device 1 according to the embodiment of the present invention includes a presentation unit which presents a temperature stimulus such that the user feels the temperature stimulus when the unit touches a part which is sensitive to a temperature stimulus and the user does not feel a temperature stimulus when the unit touches a second part which is insensitive to a temperature stimulus. The presentation unit 13 is provided at a location where the unit can touch the part sensitive to a temperature stimulus by means of an intentional action of the user. The user can receive a notification actively by intentionally causing the presentation unit 13 to contact with the first part.

Even if the presentation device 1 accidentally touches a part insensitive to a temperature stimulus, the user may not obtain information, and the user can obtain information by causing the presentation unit 13 to contact with a part sensitive to a temperature stimulus. The user can obtain information by means of a pull-type notification by causing the presentation unit 13 to contact with the part sensitive to a temperature stimulus at the desired timing.

The present invention is not limited to the above embodiment, and various modifications can be made within the scope and gist of the invention.

### REFERENCE SIGNS LIST

1 Presentation device
11 Obtaining unit
12 Control unit
13 Presentation unit

1. A presentation device, comprising:
a processor; and
a memory device storing instructions that, when executed by the processor, cause the processor to perform operations comprising:
obtaining information to be notified to a user;
inputting, to a presentation unit, an instruction for presenting a temperature stimulus if there is information to be notified to the user; and
presenting the temperature stimulus in response to the instruction for presenting the temperature stimulus received from a control unit such that the user feels the temperature stimulus when a presentation unit touches a first part, and the user does not feel the temperature stimulus when the presentation unit touches a second part which is less perceptive than the first part,
wherein
the presentation unit is provided at a position where the presentation unit can touch the first part by means of an action of the user.

2. The presentation device according to claim 1, wherein
the presentation unit is provided at a mounting fixture mounted at the body of the user and has a raised shape with respect to the mounting fixture.

3. The presentation device according to claim 1 or 2, wherein the operations further comprise:
wherein the presentation unit includes a first presentation unit and a second presentation unit, and
inputting the instruction for presenting the temperature stimulus to the first presentation unit and not inputting, the instruction for presenting the temperature stimulus to the second presentation unit.

4. The presentation device according to claim 1, wherein
the presentation unit configured to have a temperature or an area in which the user feels the temperature stimulus if the presentation unit touches the first part and the user does not feel the temperature stimulus if the presentation unit touches the second part.

5. A presenting method, comprising:
obtaining information to be notified to a user using a computer;
inputting, to a presentation unit, an instruction for presenting a temperature stimulus using the computer if there is information to be notified to the user;
presenting the temperature stimulus in response to the instruction for presenting the temperature stimulus received by the presentation unit such that the user feels the temperature stimulus when the presentation unit touches a first part and the user does not feel the temperature stimulus when the presentation unit touches a second part which is less perceptive than the first part; and
determining whether there is information to be notified by causing the presentation unit to touch the first part by the user.

6. A recording medium storing a presentation program processing program, where executing of the presentation program causes one or more computers to perform operations comprising:
obtaining information to be notified to a user;
inputting, to a presentation unit, an instruction for presenting a temperature stimulus if there is information to be notified to the user;
presenting the temperature stimulus in response to the instruction for presenting the temperature stimulus received by the presentation unit such that the user feels the temperature stimulus when the presentation unit touches a first part and the user does not feel the temperature stimulus when the presentation unit touches a second part which is less perceptive than the first part; and
determining whether there is information to be notified by causing the presentation unit to touch the first part by the user.
